(19) United States
(12) Patent Application Publication
(10) Pub. No.: US 2006/0233119 A1
(43) Pub. Date: Oct. 19, 2006

(54) Method for Parameterizing a Field Device Used in Automation Technology

(75) Inventor: William A. Cline, Troy, MI (US)

Correspondence Address: BACON & THOMAS, PLLC, 625 SLATERS LANE, FOURTH FLOOR, ALEXANDRIA, VA, 22314, US

(73) Assignee: Endress + Hauser GmbH + Co. KG, Maulburg (DE)

(21) Appl. No.: 10/532,666

(22) PCT Filed: Oct. 28, 2003
(86) PCT No.: PCT/EP03/11939

§ 371 Date: Apr. 17, 2006

(30) Foreign Application Priority Data
Oct. 31, 2002 (EP) 02024256.6

(51) Int. Cl. H04L 12/28

(52) U.S. Cl. 370/257

(57) ABSTRACT

In a method for parametering a field device of process automation technology, parametering data are exchanged by means of an on-site operating means VB of a second field device F2 via a fieldbus FB with a first field device F1 to be parametered.

The invention relates to a method for parametering a field device of automation technology, as such method is defined in the preamble of claim 1.

Field devices are often applied in automation technology, in order to register, or influence, process variables. Examples of such field devices are meters for temperature, pressure, flow, etc., which meters register the corresponding process variables temperature, pressure and flow (e.g. flowrate). Field devices, which register a process variable, are also referred to as sensors. Besides sensors, actuators (for example, valves) serve for influencing process variables.

As a rule, the field devices are connected via a fieldbus with a superordinated control unit (e.g. a programmable logic controller PLC). Frequently, the fieldbus is also connected with superordinated company networks, to which computer units are connected, which serve for purposes of display and monitoring.

Before startup and at any time for varying the functions of the field device, field devices must be parametered. For the parametering, an on-site operating means is, as a rule, available, such being integrated into the relevant field device. The on-site operating means is normally provided in the form of a display and a keypad. The display serves for, among other things, showing the current measured value of the relevant field device.

Currently, it is also possible to show, on the display of a selected field device, measured values of other field devices connected to the fieldbus.

For parametering the field devices, it is also common to use so-called handheld operating devices, which enable an easy adjustment of the field devices. To enable these handheld operating devices to gain access to a field device, they always have to be connected to the bus system, and they also require, for a comprehensive parametering, always a device description of the field device to be parametered. However, field devices are not, in every case, situated in easily accessible locations. Thus, for instance, a field device situated on the roof of a large liquid-containing tank can only be reached with difficulty by the operating personnel. For operational tasks which need to be accomplished quickly in a field device, a handheld device is not always immediately available.

With the thus-recounted possibilities, operating of a not easily accessible field device turns out to be problematic.

An object of the invention is to provide a method for operating a field device without the aforementioned disadvantages and enabling, especially, a simple and cost-favorable parametering of field devices situated in not easily accessible locations.

This object is achieved by the method defined in claim 1.

An essential idea of the invention is that the on-site operating of a second field device is used for the parametering of a first field device.

Advantageous further developments of the invention are given in the dependent claims. Thus, in a further development of the invention, the parametering data are exchanged in a proprietary protocol. With a proprietary protocol, however, only the manufacturer's own field devices can exchange parametering data. A parametering of devices of other manufacturers is, therefore, not, without more, possible.

In order to enable also the parametering of devices of other manufacturers, the parametering data are exchanged in one of the established fieldbus protocols (HART, Profibus, FF). In this case, however, only standard accesses are possible.

The invention will now be explained in greater detail on the basis of an example of an embodiment presented in the drawing, the figures of which show as follows:

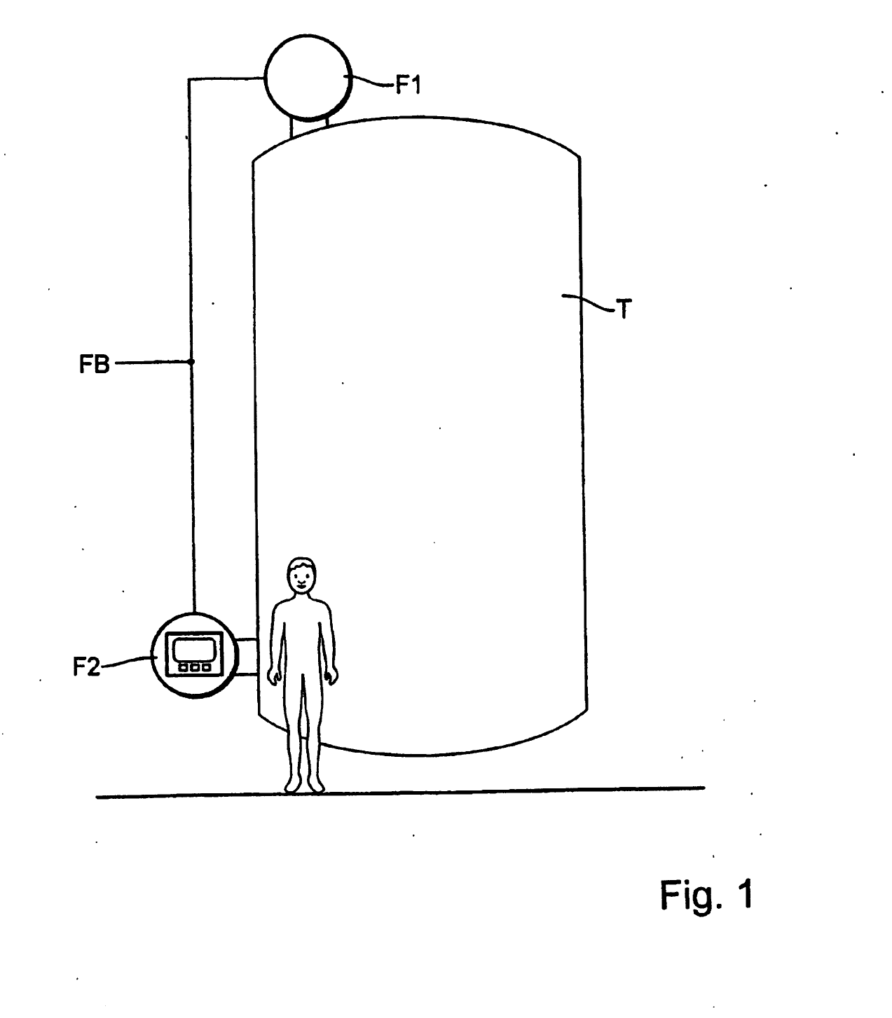

FIG. 1 a schematic drawing of a tank installation with two field devices;

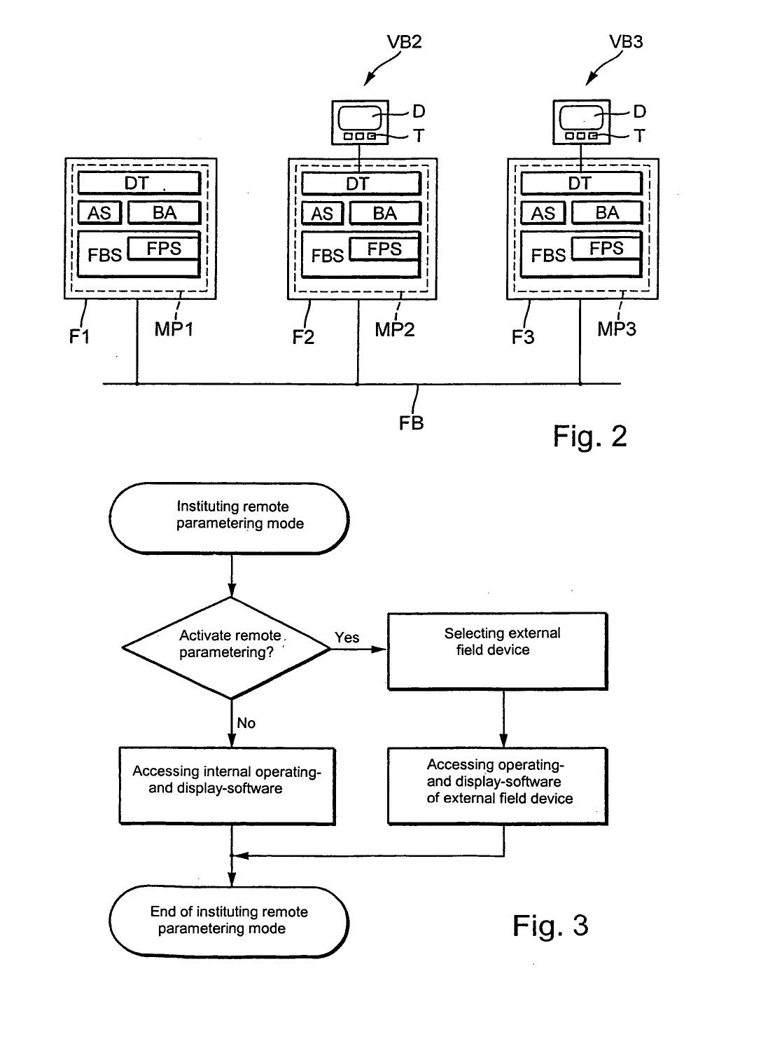

FIG. 2 a schematic presentation of a plurality of field devices connected to a fieldbus; and

FIG. 3 a flow diagram for activating the remote parametering.

FIG. 1 shows a tank T, with two field devices F1, F2 arranged at the tank. Field devices F1, F2 are connected with a fieldbus FB. Field device F1 is a fill level meter (e.g. a microwave fill level meter) and field device F2 is a pressure meter, which measures the fill level, or pressure, as the case may be, of a liquid in the tank T. Because of the ways in which they operate, field device F1 is situated on the tank roof, while field device F2 is situated in the vicinity of the floor of the tank. In order to give an indication of size relationships, a person is shown in FIG. 1. In contrast with the case for field device F1, field device F2 is easily accessible for the operating personnel.

FIG. 2 is a schematic presentation of a plurality of field devices F1, F2, F3, which are connected to the fieldbus FB. Each field device is shown to have a microprocessor MP with corresponding software components. Additionally, field devices F2, F3 are provided with on-site operating means, VB2 and VB3, respectively. These on-site operating means each include a display D and a keypad T. Each on-site operating means is actuated by a display driver DT. Beneath the display driver DT are, in each case, the evaluating software AS and the operating and display software BA. Serving for communication over the fieldbus is fieldbus communication software FBS. Additionally integrated into the fieldbus communication software FBS is a remote parametering layer FPS.

The method of the invention will now be explained in greater detail. The operating and display software BA contains a complete description of the operating structure and the presentation layout for the relevant field device (e.g. F2). In conjunction with the evaluating software AS, the settings and the output values are determined, which, with the help of the presentation layout contained in the operating and display software BA, are transformed into graphic base elements and forwarded via the display driver DT to the on-site operating means VB1 and displayed in the display D.

The fieldbus communication software FBS contains, among other things, a remote parametering layer. Via this remote parametering layer, either a request for remote parametering is initiated or an external request for remote parametering is reacted to. During the remote parametering procedure, this layer also handles the complete processing of the on-site parametering protocol.

In the case of a remote parametering, the graphic base elements of the field device to be parametered remotely (e.g. F1) are brought not only to its display driver DT, but also, via the on-site parametering protocol, to the field device (e.g. F2), which initiated the remote parametering, where it is displayed also on its display D. Operating events are transmitted from the operating device F2, via the on-site parametering protocol, to the remotely parametering device F1 and processed in its operating and display software BA. In order to enable a comprehensive operating of other field devices, a proprietary protocol is necessary. This protocol is actually a further protocol layer, which is built upon the fieldbus protocol. Devices of other manufacturers do not, however possess this layer. A complete operating of devices of other manufacturers would only be possible when device descriptions for these field devices are present in the operating field device. That is, however, too elaborate. Therefore, devices of other manufacturers can only be operated to a limited extent via standard accesses.

FIG. 3 shows a flow diagram for activating the remote parametering. If a remote parametering of a field device is to be activated, then such field device (e.g. F1) must be selected. After the selection of the field device to be parametered, then the accessing of the operating and display software BA of the field device F1 occurs from the other field device (e.g. F2).

An essential advantage of the invention is that, via the on-site operating means VB of a field device (e.g. F2), a further field device (e.g. F1) can be operated simply.

1-3. (canceled)

4. A method for parametering a process automation technology field device connected with a fieldbus, comprising the steps of:
providing a second field device connected with the fieldbus;
and providing an on-site operating means, which exchanges parametering data via the fieldbus with the first field device to be parametered.

5. The method as claimed in claim 4, further comprising the step of:
exchanging the parametering data in a proprietary protocol, which is built on top of a fieldbus protocol (HART®, PROFIBUS®, FOUNDATION FIELDBUS®).

6. The method as claimed in claim 4, further comprising the step of:
exchanging the parametering data in a fieldbus protocol (HART®, PROFIBUS®), FOUNDATION FIELDBUS®).
